(19) United States
(12) Patent Application Publication
(10) Pub. No.: US 2012/0036565 A1
(43) Pub. Date: Feb. 9, 2012

(54) PERSONAL DATA PROTECTION SUITE

(76) Inventors: Juan Gamez, Foster City, CA (US); Pankaj Srivastava, Santa Clara, CA (US)

(21) Appl. No.: 13/277,216

(22) Filed: Oct. 20, 2011

Related U.S. Application Data
(63) Continuation-in-part of application No. 12/754,086, filed on Apr. 5, 2010.

(51) Int. Cl. G06F 21/00; G06F 15/16

(52) U.S. Cl. 726/5

(57) ABSTRACT

An online protection suite that provides subscribers to organizations a highly integrated desktop application with a dashboard set of services combining single-click access to user accounts and a bulletin-board of constantly refreshed posters offering a variety of related products and services.

### COPENDING APPLICATIONS

This Application is a Continuation-in-Part of U.S. patent application Ser. No. 12/754,086, filed Jun. 5, 2010, and titled, USER AUTHENTICATION SYSTEM, this Application further claims benefit under Common Ownership, regarding United States Patent Application Publication US 2008/0028444, published Jan. 31, 2008, titled SECURE WEBSITE AUTHENTICATION USING WEBSITE CHARACTERISTICS, SECURE USER CREDENTIALS AND PRIVATE BROWSER.

### BACKGROUND OF THE INVENTION

1. Field of the Invention

The present invention relates to computer security systems, and more particularly to protection suites that present graphical user interfaces which help drive the engagement of other, related applications that can be purchased.

2. Description of Related Art

No one computer security application can do it all and free competition has resulted in hundreds, if not thousands of offerings that promise many perspectives on similar problems. Advertising has been the traditional solution to finding customer for products and for customers to understand what's available. New technologies can be “pushed” to market and market demand can “pull” sales. In a marketing “pull” system the consumer requests the product and “pulls” it through the delivery channel.

Push marketing can be interactive, especially when the Internet is used as the communications channel. Amazon and other retailers learned long ago that sales can be enhanced if they suggest or push related products to those in a buyer's “shopping cart”. Buyers are given the opportunity to click on the suggested products, often saying other buyers had bought these as well.

Protection suites are collections of best-in-class computer security products that make good sense when used in combination together. For example, NORTON™ SECURITY SUITE, IDENTITY GUARD®, SECURE BACKUP & SHARE, XFINITY™ TOOLBAR, etc.

### SUMMARY OF THE INVENTION

Briefly, an online protection suite embodiment of the present invention provides subscribers to organizations a highly integrated desktop application with a dashboard set of services combining single-click access to user accounts and a bulletin-board of constantly refreshed posters offering a variety of related products and services.

The above and still further objects, features, and advantages of the present invention will become apparent upon consideration of the following detailed description of specific embodiments thereof, especially when taken in conjunction with the accompanying drawings.

### BRIEF DESCRIPTION OF THE DRAWINGS

FIGS. 1A-1D are functional block diagrams of a user authentication system embodiment of the present invention with a network server and a client for user authentication;

FIG. 2 is a functional block diagram of a trusted network library system embodiment of the present invention that is added to support the user authentication system of FIGS. 1A-1D; and

FIGS. 3A and 3B are functional block diagrams of a user authentication method embodiment of the present invention useful in the user authentication system of FIGS. 1A-1D. FIG. 3A represents the functioning of the method when a user registers the ID vault application program for the first time. FIG. 3B represents the functioning of the method when a user should be authenticated to a corresponding server;

FIG. 4 is a functional block diagram an IAT-DLL security mender method implemented within a computer platform and configured for execution in parallel with an operating system;

FIG. 5 is a flowchart diagram of an IAT-DLL security mender method implemented as software and configured for execution by a computer platform and an operating system, and showing the interactions between them;

FIG. 6 is a functional block diagram of a secure authentication system that detects and prevents phishing and pharming attacks for specific websites, and that incorporates the elements illustrated in FIGS. 1A-1D, 2, 3A-3B, 4, and 5;

FIG. 7 is a diagram of a graphical user interface (GUI) in a dashboard configuration that can be effectively connected to and used with the system illustrated in FIG. 6; and

FIG. 8 is a functional block diagram of the mechanisms incorporated in the system illustrated in FIG. 6 that are needed to support the GUI and its hyperlinks, buttons, bulletin-board, and posters illustrated in FIG. 7.

### DETAILED DESCRIPTION OF THE INVENTION

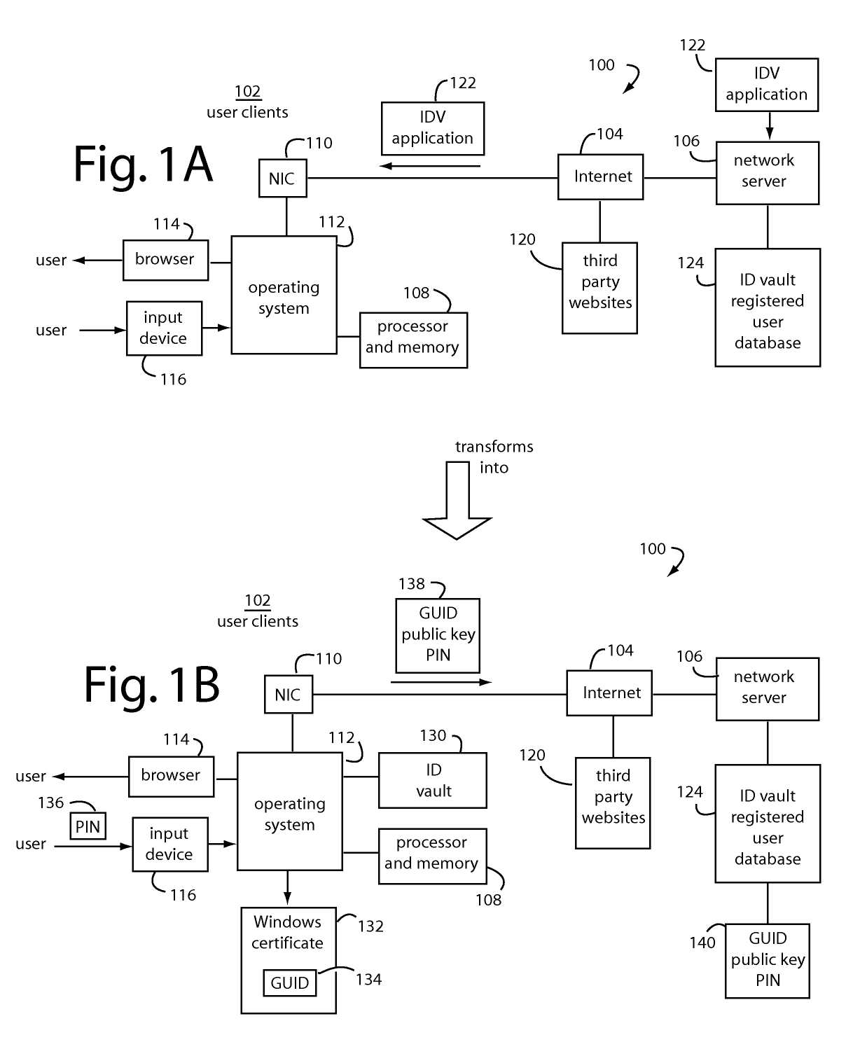

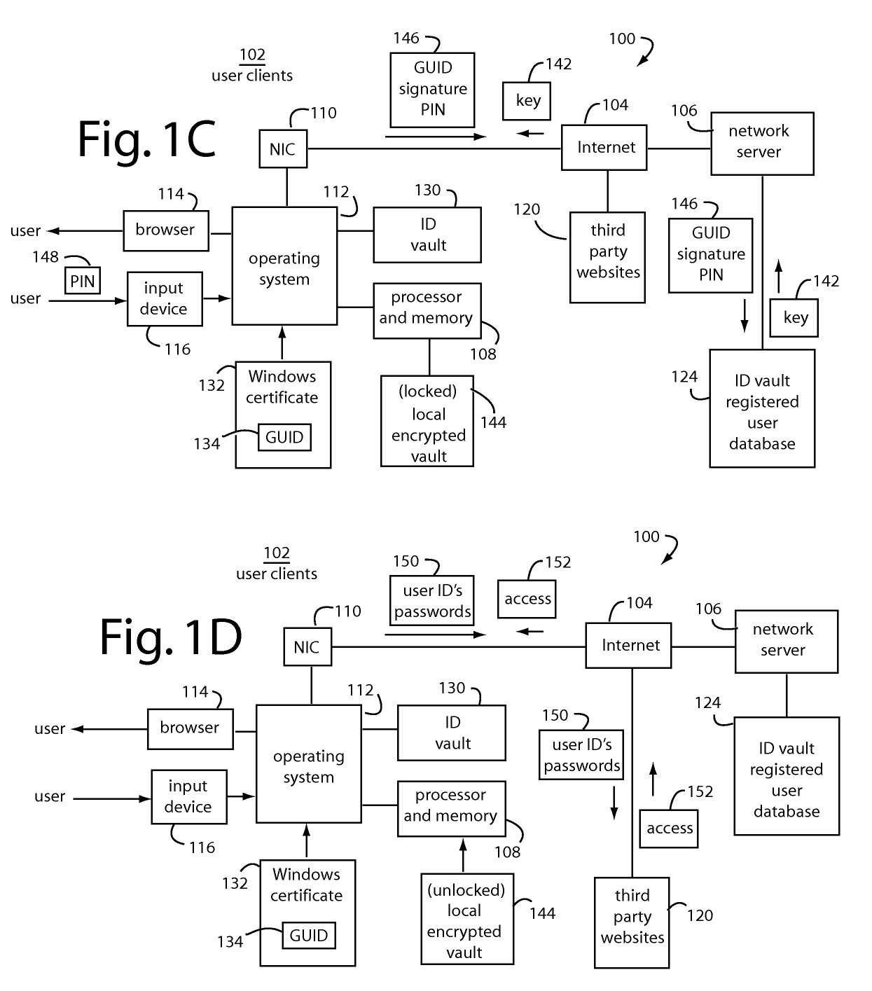

Embodiments of the present invention protect secure systems from malicious hooking of the import address table (IAT) and direct link libraries (DLL's) that can occur in standard operating systems like Microsoft WINDOWS. FIGS. 1A-1D, 2, 3A, and 3B illustrate the kind of systems that can benefit from such protection.

FIGS. 1A-1B represent a user authentication system, and is referred to herein by the general reference numeral 100. FIG. 1A represents an initial condition in which one of many user clients 102 has connected through the Internet 104 to a network server 106. The user clients 102 typically include a processor and memory 108, network interface controller (NIC) 110, an operating system 112 like WINDOWS, a browser 114 like INTERNET EXPLORER, and an input device 116 like a common keyboard and mouse. The browser 114 also allows the user clients 102 to visit third-party secure websites 120 that each require authentication from the user, e.g., a user ID and password.

Network server 106 can offer for download an ID vault (IDV) application program 122, and maintains a database 124 of registered IDV users. The IDV application program 122 can be sold, subscribed to, given away for free, offered as a prize or award, and/or provided on a disk or memory card.

FIG. 1B represents how user authentication system 100 is transformed by the installation of IDV application program 122 in user clients 102. An installation and registration process, when launched, builds an ID vault run-time client 130, a WINDOWS root certificate 132, and a globally unique identifier (GUID) 134. The WINDOWS root certificate 132 is created and signed for exclusive use by ID vault run-time client 130. There is no other root authority involved. The GUID 134 is a unique identifier earmarked exclusively for the particular installation of ID vault run-time client 130 on user client 102. When GUID 134 is created it is placed in WINDOWS root certificate 132. Network server 106 is called to create a PIN record and passes the GUID 134, the public key for WINDOWS root certificate 132, and a personal identification number (PIN) 136 provided by the user. These are forwarded in a message 138 to network server 106. The network server 106 creates a new user record 140 and stores it and others in user database 124. The particular user and their user client 102 are thereby registered.

FIG. 1C represents how the user authentication system 100 is transformed from that shown in FIG. 1B by the running of ID vault run-time client 130 in user client 102. When the user tries to open an account at a third-party website 120, a service in ID vault run-time client 130 is called to get a “protected” encryption key 142 needed to access a locked, local encrypted vault 144. That call passes a message 146 that includes a copy of GUID 134, a signature of GUID 134 using the private key for WINDOWS root certificate 132, and a freshly acquired PIN 148 (which is required to match the original PIN 136 used during registration for the user to be authenticated). Network server 106 then verifies that GUID 134 already exists in database 124, and if so, tests to see that the signature is correct using the public key previously supplied in new user record 140. It further tests to see that PIN 148 matches PIN 136 which was received previously in new user record 140. If the tests are successful, a “protected” encryption key 142 is sent to user client 102. Such “protected” encryption key 142 will expire after a limited time. But before it does expire, the user can automatically and transparently log-on to many secure third party websites 120 that its registered for.

The “protected” encryption key 142 the server returns is not the actual decryption key needed to unlock the secure files. The receiving client uses its certificate (private key) to actually decrypt key 142 and get the actual symmetric key that was used to encrypt the vault. In other words, the “protected” encryption key the server sends needs further processing by the client and its certificate before the response can be used to access the vault. The certificate and the key returned by the server are therefore strongly bound.

FIG. 1D represents how the user authentication system 100 is transformed from that shown in FIG. 1C by the routine use of ID vault run-time client 130 in user client 102. After the “protected” encryption key 142 is received, the local encrypted vault 144 can be unlocked. Thereafter, as browser 114 navigates to third party websites 120, ID vault run-time client 130 recognizes that a user ID and password 150 are needed. The local encrypted vault 144 stores all the user ID's and passwords 150 that were collected in previous sessions to automatically log-on to corresponding third party websites 120. Once logged on, the user client is given an access response 152. If a token is needed from a fob, the token is read and entered by the user as usual at input device 116. ID vault run-time client 130 will automatically relock local encrypted vault 144 after a predetermined or programmable time set by the user.

GUID 134 is a randomly generated 128-bit integer represented by a 32-character hexadecimal character string. For example, “c12eb070-2be2-11df-8a39-0800200c9a66”. The odds are that such number will be unique for all practical purposes. A GUID can be assumed to never be generated twice by any computer. Microsoft Windows uses GUID's internally to identify classes in DLL files. A script can activate a specific class or object without having to know the name or location of the Dynamic Linked Library that includes it. ActiveX uses GUID's to uniquely identify controls being downloading and installed in a web browser. GUID's can be obtained with a random-number generator, or based on a time. GUID's can also include some parts based on the hardware environment, such as the MAC address of a network card.

Certificates, like WINDOWS root certificate 132, support authentication and encrypted exchange of information on open networks such as the Internet, extranets, and intranets. The public key infrastructure (PKI) is used to issue and manage the certificates. Each WINDOWS root certificate 132 is a digitally-signed statement that binds the value of a public key to the identity of the person, device, or service that holds the corresponding private key. With conventional certificates, host computers on the Internet can create trust in the certification authority (CA) that certifies individuals and resources that hold the private keys. Trust in the PKI here is based on WINDOWS root certificate 132. Such certificates are conventionally used in secure sockets layer (SSL) sessions, when installing software, and when receiving encrypted or digitally signed e-mail messages.

The Update Root Certificates feature in Windows Vista is designed to automatically check the list of trusted authorities on the Windows Update Website when this check is needed by a user's application. Ordinarily, if an application is presented with a certificate issued by a certification authority in a PKI that is not directly trusted, the Update Root Certificates feature will contact the Windows Update Website to see if Microsoft has added the certificate of the root CA to its list of trusted root certificates. If the CA has been added to the Microsoft list of trusted authorities, its certificate will automatically be added to the set of trusted root certificates on the user's computer.

When a certification authority is configured inside an organization, the certificates issued can specify the location for retrieval of more validation evidence. Such location can be a Web server or a directory within the organization.

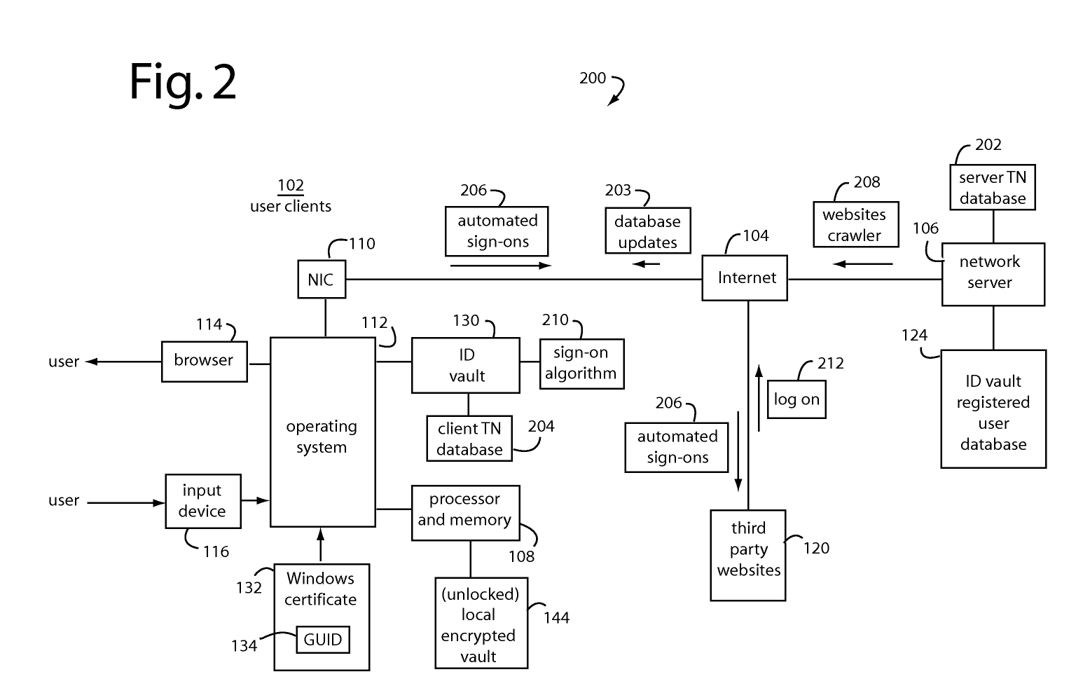

FIG. 2 represents a trusted network library system 200 in an embodiment of the present invention that can be included with the user authentication system 100 of FIGS. 1A-1D. The items in FIG. 2 that are the same as those in FIGS. 1A-1D use the same numbering. Elements of trusted network library system 200 would normally be installed as part of the installation process for ID vault run-time client 130.

The trusted network library system 200 builds a server TN database 202 of trusted third-party websites 120, and is periodically copied in an update 203 to user clients 102 as a client TN database 204. And to control spoofing, client TN database 204 itself is preferably read-only, encrypted, and secure after being installed.

Each entry in server TN database 202 includes a list of websites that are trusted, a description of corresponding sign-on elements and protocols 206 for each website, and any sign-on flags. It could also include websites to avoid. About 8,000 trusted websites would be typical, and these span the range of secure websites that a majority of Internet users would register with and do business.

The Internet 104 and the third-party websites 120 are very fluid and ever changing in the number and qualities of the websites, and so keeping server TN database 202 fresh and up-to-date is an on-going challenge. The construction and testing of server TN database 202 can be automated for the most part, e.g., with a web-site crawler 208. But a professional staff can be needed to guide and support the results obtained so questions can be resolved as to which third-party websites 120 to trust, which are abusive, what protocols to use, and for each, what are the proper mix of sign-on elements. These are collectively embodied in a logical step-by-step procedure executed as a program by processor and memory 108, referred to herein as a sign-on algorithm 210. Each successful use of sign-on algorithm 210 will result in a third-party log-on 212 for the corresponding user client 102.

Keeping the client TN database 204 as up-to-date as possible allows user clients 102 to successfully log-on quickly, it also prevents screen scraping by hiding the sign-on session, and further frustrates attempts at key logging and pharming. Having to download server TN database 202 in real-time every time it is needed is not very practical or desirable. And the connection to network 106 can be dropped or lost without causing interruptions, as long as the local encrypted vault 144 remains unlocked.

The client TN database 204 is preloaded with bundles of data that include, for each of thousands of third-party websites 120, a description of its sign-on elements, IP-data, and sign-on flags. Such data helps the ID vault 130 recognize when the user has navigated to a secure website with the browser 114. The description of sign-on elements describes user name, password, submit buttons, protocols, page fields, etc. The IP-data includes anti-phishing and anti-pharming information. The sign-on flags are used to turn on and turn off special scripts and algorithms 210.

In an alternative embodiment, the whole contents of server TN database 202 are not preloaded into client TN database 204. Only the specific bundle for a particular third party website 120 is downloaded the first time the user navigates browser 114 to the log-on page. Thereafter, the client TN database 204 retains it for repeated visits later. Only if the retained copy fails to work will another download be attempted to fetch an update that may have occurred in server TN database 202.

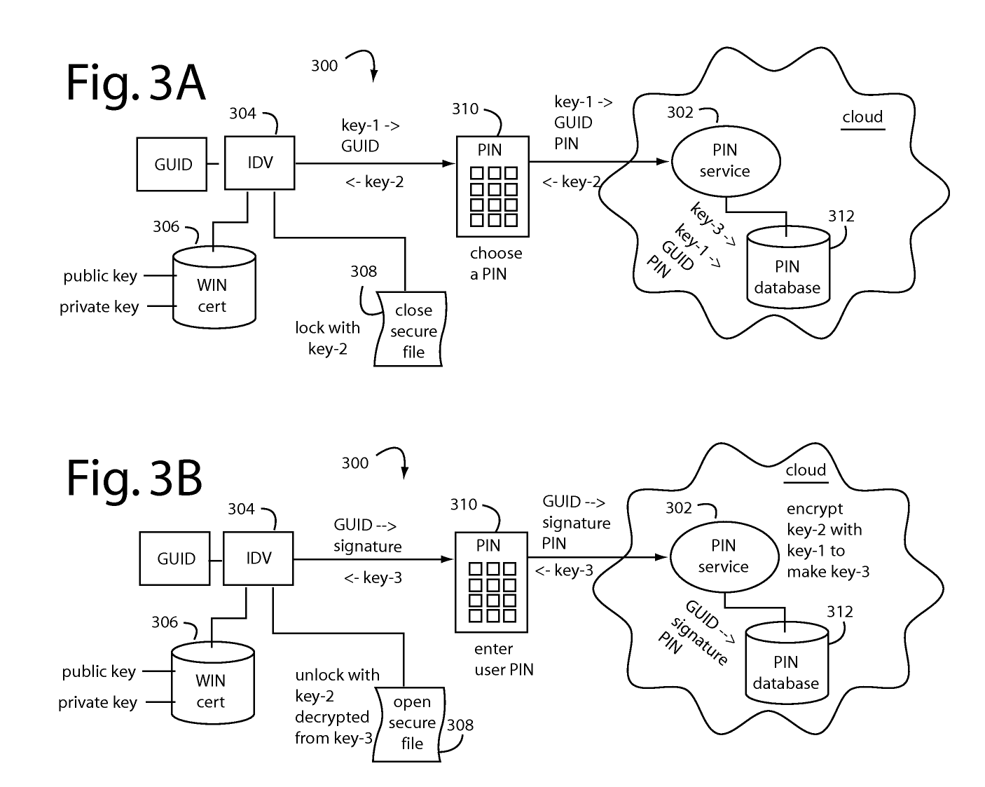

FIGS. 3A and 3B represents a method embodiment of the present invention for user authentication, and is referred to herein by the general reference numeral 300. Method 300 is implemented with computer software that executes on the personal computers and mobile wireless devices of users and at least one network server 302 that includes a PIN service. An ID vault application program 304 is loaded on the user's personal computer or mobile wireless device. It uses public key infrastructure (PKI) encryption to create a single, unique, non-exportable certificate 306 when ID vault application program 304 is installed. A secure file 308 is encrypted with symmetric encryption with a secret key provided by the server 302. The server encrypts the secret key using the public key provided by ID vault application program 304. Then ID vault application program 304 can decrypt it using its private key. The network server 302 will provide those keys only after the user supplies a fresh PIN pad dialog 310 and a check is made to see that non-exportable certificate 306 is correct for this user. Both PIN pad dialog 310 and non-exportable certificate 306 are gathered into a PIN database 312 during an initial registration process for ID vault application program 304. As such, non-exportable certificate 306 (something you have) serves as one of two authentication factors. PIN pad dialog 310 (something you know) serves as the mechanism to input the second authentication factor.

The non-exportable certificate 306 creates a pair of asymmetric encryption keys, one private and one public according to Public Key infrastructure (PKI). In cryptography, a PKI is an arrangement that binds public keys with respective user identities by means of a certificate authority (CA). The user identity is unique within each CA domain. The binding is done during a registration and issuance process. A Registration Authority (RA) assures the binding. The user identity, the public key, their bindings, validity conditions, etc. cannot be faked in public key certificates issued by the CA.

When a user registers ID vault application program 304 for the first time, as in FIG. 3A, each client sends their certificate's public key (key-1), a self-generated GUID, and a PIN they've chosen. The server 302 generates a symmetric key (key-2), and then encrypts key-2 with the supplied key-1, producing a key-3. Key-2 is the actual key for encrypting/decrypting the vault, secure file 308. All the information passed including key-3 are stored in the PIN store database 312. For access to key-2, the certificate's private key is needed to decrypt key-3.

Thereafter, when client 304 has to authenticate a user, as in FIG. 3B, it sends the GUID, a signature of the GUID using the certificate's private key, and a freshly acquired PIN entered at PIN pad 310. Server 302 makes various the tests described above, and sends back key-3. Key-3 is received by the client 304, decrypted to get key-2, and at that point the vault secure file 308 can be accessed using key-2. Only a machine holding the correct certificate can decrypt key-3 because the key-3 was created by using the certificate's public key.

ID vault application program 304 passes its public key for non-exportable certificate 306 to network server 302, e.g., a key-1. The network server 302 uses a symmetric encryption process with a “secret key”, key-2, to encrypt key-1. This produces a key-3 that is stored in PIN database 312. The PIN database 312 is secure from attack because the attackers would need to have access to PIN database 312 and key-1, for every user. Key-2 is returned to ID vault application program 304 so that it can create or unlock encrypted file 308. The key-2 held by ID vault application program 304 is destroyed after it has served its purpose. A new key-2 will therefore be requested to be supplied from network server 302 the next time encrypted file 308 needs to be unlocked. That request will require a fresh entry of PIN pad dialog 310 and an asymmetrically encrypted signature from non-exportable certificate 306. Such signature can include a GUID. The number of failed attempts to authenticate the user and their computer to the server are limited.

A particular vulnerability can occur in the systems illustrated in FIGS. 1A-1D, 2, 3A, and 3B, such as in operating system 112. ID Vault 130, for example, depends on the operating system 112 to securely forward user ID's and passwords 150, and automated sign-ons 206, to network server 106. But malware infecting operating system 112 can highjack the basic system input and output mechanisms, especially if they use Microsoft WINDOWS type import address tables (IAT) and direct linked libraries (DLL's).

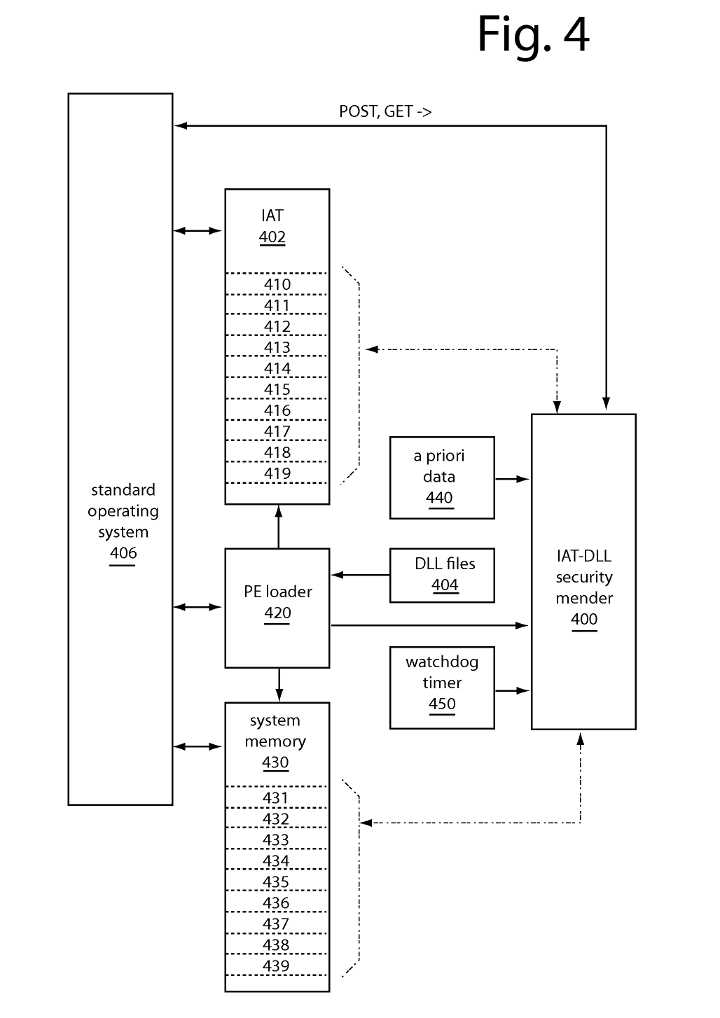

FIG. 4 represents an IAT-DLL security mender in an embodiment of the present invention, and is referred to herein by the general reference numeral 400. IAT-DLL security mender 400 has access to the IAT 402 and DLL files 404 in a standard operating system 406. IAT 402 comprises a table of individual program address pointers 410-419. Initially, these program address pointers 410-419 are null and are computed and set by a PE loader 420 whenever a DLL file 404 is loaded by the operating system into a system memory 430. Each of several executable files 431-419 has absolute addresses assigned during run-time, and pointers to these are fixed as one or more of address pointers 410-419 in IAT 402 by PE loader 420.

IAT-DLL security mender 400 monitors and repairs a limited number of the executable files 431-419 in system memory 430 and the address pointers 410-419 in IAT 402. IAT-DLL security mender 400 has a priori knowledge of the correct values for selected executable files 431-419 and address pointers 410-419. Such is typically provided in an a priori data file 440.

A watchdog timer 450 or PE loader 420, or both, trigger IAT-DLL security mender 400 into action. The a priori data file 440 is consulted for which executable files 431-419 and address pointers 410-419 to write, and what to write them with. Alternatively, the executable files 431-419 and address pointers 410-419 can be consulted for their virgin values when PE loader 420 supplies a trigger indicating that it has acted. The consulted values are stored by IAT-DLL security mender 400 for use later in mending operations. Parts of the a priori data file 440 could be computed by IAT-DLL security mender 400 from the DLL files 404 before their being loaded into system memory 430. The IAT-DLL security mender 400 and a priori data file 440 can themselves be generated and installed by a DLL file 404, especially one bundled with a user-credentials application DLL as in FIGS. 1A-1D, 2, 3A, and 3B.

In one alternative mode of operation, IAT-DLL security mender 400 launches every time sensitive data is about to be sent to a secure webserver. But running IAT-DLL security mender 400 on every HTTP GET or POST operation when logging on to an https-server can inject delays that may be objectionable. The POST request method is used when a client sends data to the server as part of a request, e.g., when uploading a file or submitting a completed form. The GET request method sends only a uniform resource locator (URL) and headers to the server. In contrast, POST requests include a message body. So POST requests allow any type of arbitrary length data to be sent to the server.

In commercial products installed on preexisting computer and operating systems 406, at least one of DLL files 404 can be bundled for sale with IAT-DLL security mender 400 and a priori data 440.

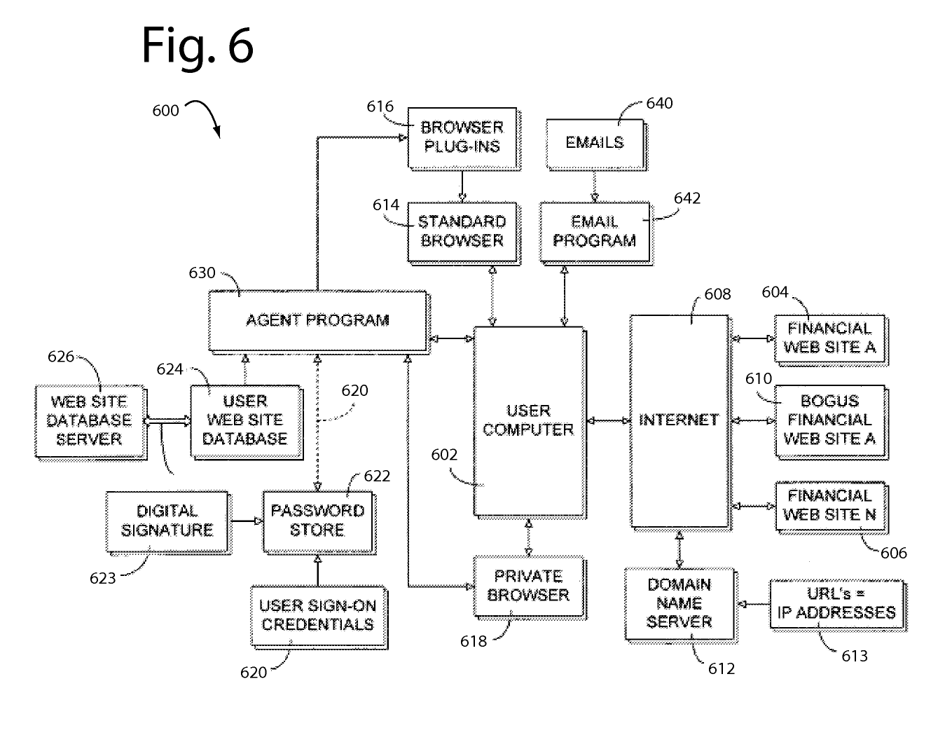

FIGS. 1A-1D, 2, 3A, and 3B, should be considered herein to include IAT-DLL security mender 400, e.g., within operating system 112 (FIGS. 1A-1D and 2) and/or ID vault application program 304 (FIGS. 3A-3B). IAT-DLL security mender 400 would also be beneficial if installed in other similar systems, such as in system 600 illustrated in FIG. 6.

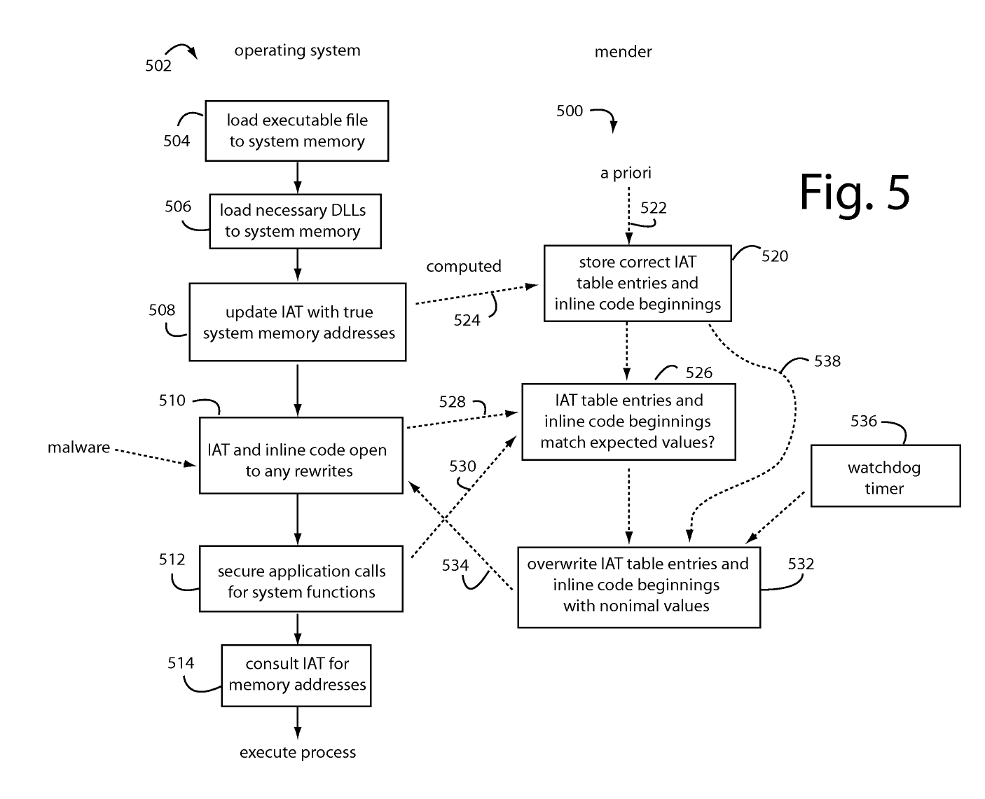

FIG. 5 represents an IAT-DLL security mender method embodiment of the present invention implemented as software and executed by conventional computer platforms. An IAT-DLL security mender 500 is associated with an operating system 502 like Microsoft WINDOWS. The operating system 502 includes a process 504 to load executable files into system memory, and a process 506 to read those files and load any DLLs that will be needed. A process 508 updates an import address table (IAT) with pointers to the real system memory addresses. A process 510 represent the open nature of the IAT and inline code, and their vulnerabilities to malware.

A secure application that needs protection from IAT and inline hooking calls for system functions implemented by the executable files and DLLs in a process 512. The secure application consults the IAT for the real memory addresses in a process 514 and executes.

IAT-DLL security mender 500 runs in parallel and has access to the IAT and inline code in system memory. A process 520 stores the correct IAT table entries and inline code beginnings, either from a priori data 522 or from computed values 524. A process 526 fetches particular IAT table entries and inline code beginnings for comparison with what they should be. A link 528 provides current values. If the values are other than expected, the system administrator can be alerted to the possibility of malware activity. Process 526 can be triggered to execute by a link 530 whenever the secure application calls for system functions.

A process 532 overwrites particular and sensitive IAT table entries and/or inline code beginnings. A link 534 provides access. Alternatively, a watchdog time 536 s used to decide when process 532 should operate.

In alternative embodiments of the present invention, IAT-DLL security mender 500 skips process 526 and just proceeds directly from process 520 to process 532 on a link 538.

United States Patent Application Publication US 2008/0028444, published Jan. 31, 2008, titled SECURE WEBSITE AUTHENTICATION USING WEBSITE CHARACTERISTICS, SECURE USER CREDENTIALS AND PRIVATE BROWSER, describes a secure authentication system that detects and prevents phishing and pharming attacks for specific websites. The basic system with improvements described herein is represented in FIG. 6 and referred to herein by the general reference numeral 600. White Sky, Inc., is the Common Owner and Assignee of both the Present Application and that embodied in United States Patent Application Publication US 2008/0028444.

System 600 is an embodiment of the present invention that attaches to conventional elements such as a user computer 602 that can access legitimate financial websites 604 and 606 through the Internet 608. Bogus websites 610 can impersonate legitimate ones and are detected and recognized as being false by system 600. A conventional domain name server (DNS) 612 provides true IP-addresses 613 when a standard browser 614 is used to surf the Internet 608 and gives it a target uniform resource locator (URL) to start with. This standard browser accepts conventional browser plug-ins 616. Bogus websites 610 try to confuse users by posting deceptive and similar looking URL's, but these will translate by the DNS 612 to very different, and wrong IP-addresses. For example, “citibank.com” and “citybank.com” will have very different IP addresses, one benign and one malicious. Users never see the actual IP address they wind up at, and if they do it's just meaningless numbers. Once a user logs on to a malicious website, they become a new victim.

A private secure browser 618 presents a user display window referred to herein as “SECURE VIEW”, and it can only be directed to particular websites by agent program 610, and not by the user. It has no address line to input URL's, and it does not permit browser plug-ins 616 like standard browsers 614 do. In some embodiments, when a user navigates to a website using standard browser 614, private browser 618 will pop up and replace the standard browser's user display window. This is especially true when the user attempts to provide user credentials 620, such as a User-ID and password.

A dedicated secure hardware store 622 keeps user sign-in credentials 620. A digital signature 623 is occasionally needed to keep the secure hardware store 622 open, e.g., for thirty minutes or until the user logs out. A database 624 of information about specific websites is refreshed by a website database server 626. All user web activity is monitored by an agent program 630. When the user attempts to send sign-in credentials 620 to any website, agent program 630 will allow and control it if the IP address of the website's IP address matches an IP addresses already stored in the website database 624. Such IP-addresses must correspond with those registered to the sign-in credentials the user is attempting to send.

System 600 will detect mismatches between URL's and the legitimate IP-addresses belonging to those websites. This and the use of private browser 618 provides better protection by not allowing user credentials (ID, passwords, etc.) to be supplied to any websites unless the destination URL is one that is known, verified, and trusted.

When a user sends anything to a website, agent program 630 checks the POST data text against all the user credentials 620 which are stored in password store 622. If it seems no user credentials are being attempted to be sent, agent program 630 will allow the data to be passed on to the website.

However, if a match occurs, it means the user is attempting to POST a sign-on credential. In such case, agent program 630 fetches an IP address that gets returned from the contacted website, and compares that with an IP address previously stored in the user website database 624 and that is associated with the particular sign-on credential being proposed.

If no user-credential to IP-address match occurs, the agent program 630 warns the user that they may be compromising their account if they are not sure the site is legitimate, and it can prevent the user from sending the sign-on credential.

Normally, if there is match, that indicates the website contacted is expected correct website because it was previously associated with the sign-on credential that was detected. The agent program 630 then activates private browser 618 to conduct the secure session. The sign-on credential is retrieved from the password store 622 and it is sent to the proper website through private browser 618.

If the credential is accepted by the website contacted, a user session is opened only in the private browser. But this can sometimes fail and special procedures are needed for particular websites like citibusiness.com and paypal.com working through ebay.com. Appropriate access is conducted to the financial websites with which the user has accounts, and prevents any access with bogus websites. Or it at least warns the user that the website the user is attempting to contact is not the trusted website.

Conventional emails 640 can be received and sent by a conventional email program 642 installed on user computer 602.

User computer 602 would normally suffer from the security vulnerabilities to malicious program hooking of its operating system's portable execution format files and import address tables (IATs). So, system 600 includes in user computer 602 the devices and methods described herein in connection with FIGS. 1-5.

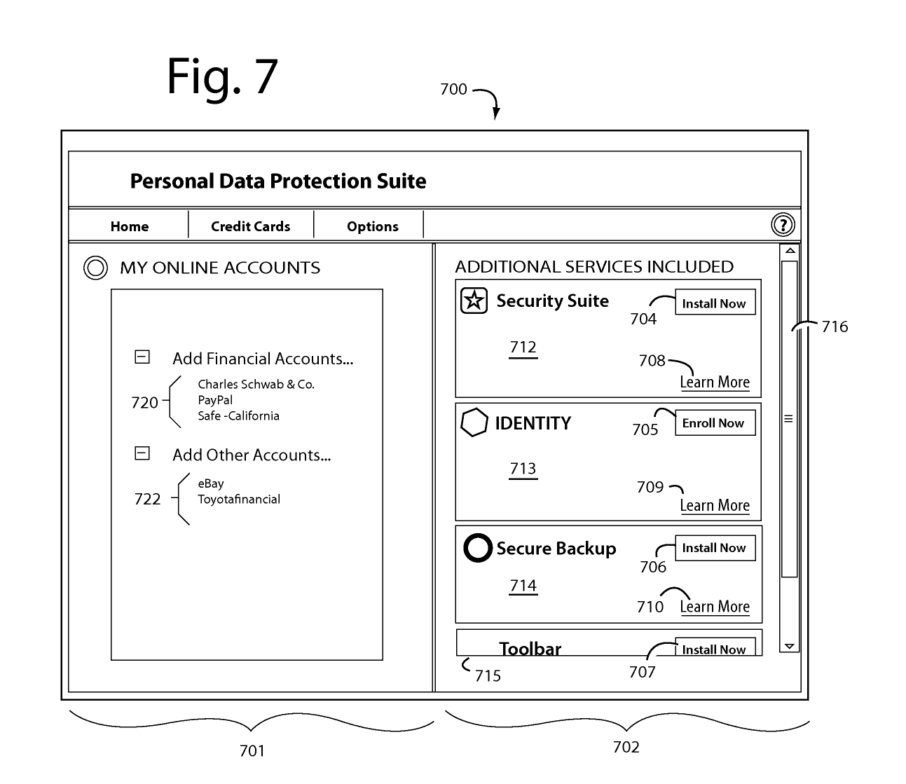

FIG. 7 represents a graphical user interface (GUI) 700 in a dashboard configuration that can be effectively connected to and used with system 600 (FIG. 6). GUI 700 is a type of user interface that allows users to interact with images rather than text commands. It is implemented as a display image window on a user display connected to user computer 602 and works with a mouse pointing device. Standard browser 614 and private browser 618 also display windows on such user display.

GUI 700 includes a split into two or more parts, e.g., a left half 701 and a right half 702. Here, the left half 701 is devoted to managing the protection mechanisms described in connection with FIG. 6. The right half 702 is devoted toward driving the purchase and engagement of related security applications and services that can be downloaded and run effectively in combination with system 600 and GUI 700. As a consequence, the right half 702 benefits from the constant exposure to the users' “eyeballs”. The split into left and right halves 701 and 702 is arbitrary, and such could be reversed and still yield the same benefits.

In the example, FIG. 7 represents a protection suite embodiment of the present invention that has been marketed by White Sky, Inc. as its PERSONAL DATA PROTECTION SUITE™ and distributed by XFINITY to its high-speed Internet customers. The theme here is computer security, and the left and right halves 701 and 702 are complementary. Other themes are possible where the services offered enhance the main application and user interests. In the case of Internet Service Providers (ISP's) and others like XFINITY, they offer several benefits to their subscribers that can be collected and presented in an organized way on the right half 702. Otherwise, these many benefits can go unrecognized and underutilized by the population of subscribers and customers. The American Association of Retired Persons (AARP) would be another example of an organization that offers hundreds of programs and benefits to its members, such as health insurance, hotel discounts, travel incentives, Social Security, voting and campaigns, etc. Here, the left half 701 would be used for AARP functions, and the right half 702 for services, programs, and discounts offered only to AARP members.

As used herein, a hyperlink is a reference to a document that a reader can follow directly or automatically. They can be represented as highlighted or underlined text, or as buttons that look like they could be pushed with a finger. Hyperlinks can point to whole documents or webpages, or to specific elements within them. Hypertext is text that embeds hyperlinks. Hyperlinks have anchors which are the locations within documents from which hyperlinks are followed. The document with the hyperlink is the source document. The target of the hyperlink can be a document, or a location within a document to which the hyperlink points. Users can activate and follow links when their anchors are shown, e.g., by clicking on the anchor with a mouse. Engaging the link can display the target document, or start a download, or open a webpage.

Returning to FIG. 7, the right half 702 has several offers-to-sell equipped with clickable hyperlink button controls, e.g., 704-707. (Herein “sell” can also include give away for free.) Some button controls say “Install Now” and others say “Enroll Now”. Clicking on these buttons will take the user to the respective providers' websites where they can purchase, download, and install the respective applications. E.g., a security suite like anti-virus, an identity theft monitoring service, a cloud type backup service, and a specialized toolbar. Clicking on a “Learn More” link 708-710 will merely cause more information to be displayed in the standard browser so a purchasing decision can be made by the user.

The right half 702 illustrated in FIG. 7 is an “additional services offered” bulletin-board, populated in this example with four offer-to-sell hypertext posters 712-715. More than the four shown could be included and accessed by manipulating a scroll bar 716. Such posters can be dynamic and ever-changing in their offers and sponsoring organizations. The sponsoring organization controls which posters are offered and how.

Sponsors, providers, and other advertisers can be charged for their appearances in offer-to-sell hypertext posters 712-715, with a premium being charged for the first few positions on top. A check of user computer 602 (FIG. 6) is made to see if any of these services offered are already installed and functioning.

Once the respective service is purchased and installed, the “Install Now” legend on the hyperlink control button changes from red to a green, “Launch” button or something equivalent for centralized, one-click access.

The left half 701 also presents an opportunity to do a bit of marketing. When GUI 700 is initially opened by a new user, links 720, 722 to various sponsors can be pre-installed. Eventually, these links will be populated by financial and other kinds of accounts at websites where the user has user-ID and password credentials established. Font colors can be used to indicate which of these links is suggested and which are registered in the application.

Users can navigate to a website that requires their user credentials by using standard browser 614, or by clicking on the respective link 720, 722 in GUI 700. Either action will result in private browser 618 putting up a SECURE VIEW window. If this is the first use of system 600 in a while to access a secure website, agent program 630 will pop-up a dialog box requiring the user to input their master pin, e.g., digital signature 623. The target website opens immediately in the SECURE VIEW window. If a window in the standard browser 614 was used, that window closes to prevent confusing the user and to prevent transactions outside the SECURE VIEW window.

Links 720, 720 represent “single-click access” to the secure websites visited by the user and the necessary mechanics to enable customized access are stored in website database 624 (FIG. 6). The corresponding user credentials for these websites are securely stored in password store 622.

The logic to implement the functions described for GUI 700 are embodied in DLL files and loaded in user computer 602 as portable executables (PE) in the WINDOWS operating system, for example. System functions like presenting windows and pop-ups, supporting pointing devices, responding to clickable links and buttons, opening up network sessions and accessing websites, are all conventional technologies provided by widely available commercial products like Microsoft's WINDOWS operating system. Protecting some of the vulnerable aspects of these conventional technologies falls on mender 400, as described herein in connection with FIGS. 4-5.

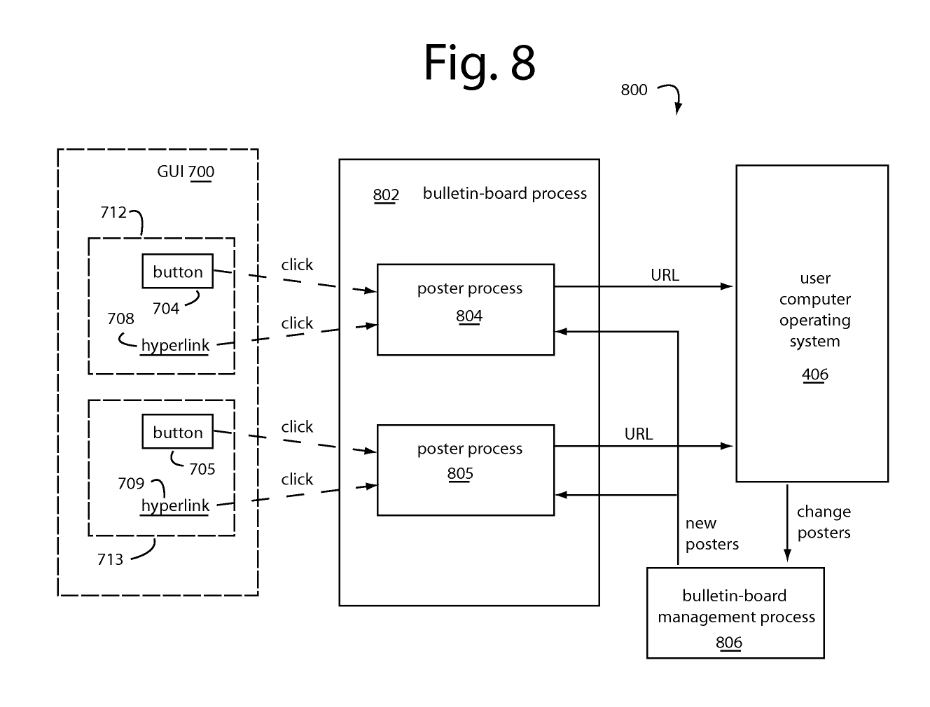

FIG. 8 represents a mechanism 800 incorporated into system 600 (FIG. 6) to support GUI 700 and its hyperlinks 708-710, buttons 704-707, bulletin-board 702, and posters 712-715. In one embodiment, these mechanisms are implemented as PE files in DLL's 404 (FIG. 4) loaded, as needed, by the operating system 406. In GUI 700 as it's displayed on a user screen, clicking on a control button 704 or 705, or a hyperlink 708 or 709, in a poster 712 or 713, will send a trigger to a bulletin-board process 802. A corresponding poster process 804 or 805 has the particulars of the target URL to go to and such is forwarded to the user computer operating system 406. If a request to change, update, add, or remove a poster is received by the user computer operating system 406, a bulletin-board management process 806 will install the appropriate poster process and update the GUI 700.

In summary, online protection embodiments of the present invention provide subscribers to organizations a highly integrated desktop application with a dashboard set of services combining single-click access to user accounts and a bulletin- board of constantly refreshed posters offering a variety of related products and services.

Although particular embodiments of the present invention have been described and illustrated, such is not intended to limit the invention. Modifications and changes will no doubt become apparent to those skilled in the art, and it is intended that the invention only be limited by the scope of the appended claims.

The invention claimed is:

1. A computer desktop display dashboard configured for subscribers to a single organization, comprising:
an interactive graphical user interface (GUI) for presentation on a user display in a window having a split into a first part and a second part;
a financial account list of hyperlinks disposed in said first part and providing access to preregistered financial websites with which the user has previously established user credentials for secure network sessions;
a non-financial account list of hyperlinks also disposed in said first part and providing access to preregistered non-financial websites with which the user has previously established user credentials for secure network sessions; and
an electronic bulletin-board disposed in said second part; and
at least one offer-to-sell hypertext poster posted in the bulletin-board.

2. The computer desktop display dashboard of claim 1, further including in each said poster an install-now hyperlink button and a learn-more link, wherein each mechanize a link to a third party website configured to be launched thereby to complete a download and installation of a corresponding user application program to the user computer.

3. The computer desktop display dashboard of claim 1, further including:
a bulletin-board management process to populate the bulletin-board with new or different posters, wherein each poster is supported by a poster process to mechanize a link to corresponding third-party websites, and that are configured to be launched thereby to complete a download and installation of a respective user application program to the user computer.

4. The computer desktop display dashboard of claim 1, further including:
a hyperlink control button included in each offer-to-sell hypertext poster, and configured to link to a third-party website for an application download if such application is not already installed on the user computer.

5. A computer security system for a user computer configured for Internet access, comprising:
an interactive graphical user interface (GUI) for presentation on a user display in a window having a split into a first part and a second part;
a financial account list of hyperlinks disposed in said first part and providing access to preregistered financial websites with which the user has previously established user credentials for secure network sessions;
a non-financial account list of hyperlinks also disposed in said first part and providing access to preregistered non-financial websites with which the user has previously established user credentials for secure network sessions; and
at least one offer-to-sell hypertext disposed in said second part and including an install-now hyperlink button and a learn-more link, wherein each mechanize a link to a third party website configured to be launched thereby to complete a download and installation of a corresponding user application program to the user computer.

6. The computer security system of claim 5, further comprising an IAT-DLL security mender process implemented as software and configured for execution by said user computer and an operating system, wherein the operating system includes a process to load executable files into system memory, a process to read those files and load any direct linked libraries (DLLs) that will be needed, a process to update an import address table (IAT) with pointers to real system memory addresses, and applications vulnerable to malware hooking, wherein secure applications must consult the IAT for the real memory addresses in order to execute them, the IAT-DLL security mender process comprising:
a process configured to store nominal IAT table entries and inline code beginnings, from either a priori data and/or from computed values;
a process for fetching particular IAT table entries and inline code beginnings for comparison with expected values;
a process configured to overwrite particular IAT table entries and/or inline code beginnings with nominal IAT table entries and inline code beginnings;
wherein, the IAT-DLL security mender runs in parallel with the operating system and has access to its IAT and inline code in system memory.

7. An online protection suite configured to provide subscribers to organizations a highly integrated desktop application on a user computer with a dashboard set of services combining single-click access to user accounts and a bulletin-board of constantly refreshed posters offering a variety of related products and services through hyperlink control buttons.
